(19) United States
(12) Patent Application Publication
(10) Pub. No.: US 2020/0169586 A1
(43) Pub. Date: May 28, 2020

(54) Perspective Shuffling in Virtual Co-Experiencing Systems

(71) Applicant: Facebook Technologies, LLC, Menlo Park, CA (US)

(72) Inventors: Difei Wang, Redwood City, CA (US); Matthew Luther, Palo Alto, CA (US); Lam Nguyen, South San Francisco, CA (US); Monique Relova, South San Francisco, CA (US); German Bauer, San Jose, CA (US)

(21) Appl. No.: 16/199,722

(22) Filed: Nov. 26, 2018

(51) Int. Cl. H04L 29/06; G06T 19/00; G06T 17/00

(52) U.S. Cl. CPC H04L 65/1073; G06T 19/006; G06T 2219/024; G06T 17/00; H04L 65/1069

(57) ABSTRACT

In one embodiment, a method includes connecting to a virtual session for co-experiencing digital media content with one or more other users in a virtual reality environment, where the virtual reality environment comprises a screen for displaying the digital media content, receiving relative-position information indicating relative positions between the first user and the one or more other users in the virtual reality environment, rendering the screen based on a first position of the first user in the virtual reality environment, wherein the screen and the first position of the first user have a predefined spatial relationship in the virtual reality environment, and rendering, based on the received relative-position information and the first position of the first user, a second avatar representing a second user in the virtual reality environment, wherein the second user is one of the one or more other users.

### TECHNICAL FIELD

This disclosure generally relates to Virtual Reality (VR) systems, and in particular related to consuming digital content in a virtual environment.

### BACKGROUND

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

In particular embodiments, a computing device associated with an artificial reality system may provide a distortion-free viewing position (e.g., centered) to a user who is co-experiencing digital content with the other users in a virtual environment. An artificial reality system may allow a plurality of users associated with virtual reality (VR) devices to co-experience digital content, such as a sports event, a movie or a TV show. Because co-experiencing is a social event among the participating users, the participating users may need to be able to look at each other while the users are talking to each other even though a visual presentation of a user in the virtual environment may be a digital avatar, not the user herself. Thus, avatars representing respective users may be placed on a curved seat in the virtual environment. If the screen is placed right in front of the centered user, the other users on each side may experience image distortion because the users are viewing the screen at an angle. Furthermore, users sitting on the extreme right or left may be too close to the screen. The virtual co-experiencing system may allow each user to face the screen right in front of the user. When a first user joins a virtual digital content co-experiencing event, a first computing device associated with a VR device for the first user may determine a first position of the first user in the virtual environment rendered by the first computing device. The first computing device may render a screen in the virtual environment rendered by the first computing device such that the screen and the first position may have a predefined spatial relationship. The predefined spatial relationship between the screen and the first position of the first user may be that the screen may be positioned at a predetermined distance from the first position and the screen may be centered at and perpendicular to a sightline of the user when the user faces forward. The first computing device may render a second avatar representing a second user that is also participating to the virtual digital content co-experiencing event at a second position, where a spatial relationship between the first position and the second position may be received from a computing device, and where the screen and the second position may not have the predefined spatial relationship. A second computing device associated with a VR device for the second user may determine a third position of the second user in the virtual environment rendered by the second computing device. The second computing device may render a screen in the virtual environment rendered by the second computing device such that the screen and the third position may have a predefined spatial relationship. The second computing device may render a first avatar representing the first user at a fourth position, where a spatial relationship between the fourth position and the third position in the virtual environment rendered by the second computing device may be identical to the spatial relationship between the first position and the second position in the virtual environment rendered by the first computing device. The screen and the fourth position may not have the predefined spatial relationship in the virtual environment rendered by the second computing device.

While the users are co-experiencing the digital content in the virtual environment, the users may communicate with each other by talking to each other, looking at each other (more specifically, looking at each other's avatar). An avatar needs to represent the current situation of the corresponding user as close as possible at any given point of time. When a first user and a second user are watching the screen in their respective virtual environments rendered by respective computing devices, both the first user and the second user may sense that the screen is right in front of her/him. Thus, the first user and the second user may face the screen directly. However, from the first user's perspective, the screen-watching second user may turn his face slightly towards the screen that is right in front of the first user because the second user may not be positioned right in front of the screen. The computing device associated with the first user may render an avatar for the second user as if the second user turns his face to the screen while the second user is facing his own screen. The computing devices may communicate with each other to share current facial directions of respective users.

A first computing device associated with a first user may connect to a virtual session for co-experiencing digital media content with one or more other users in a virtual reality environment, wherein the virtual reality environment may comprise a screen for displaying the digital media content. The first computing device may receive relative-position information indicating relative positions between the first user and the one or more other users in the virtual reality environment. The first computing device may render the screen based on a first position of the first user in the virtual reality environment, wherein the screen and the first position of the first user may have a predefined spatial relationship in the virtual reality environment. The first computing device may render, based on the received relative-position information and the first position of the first user, a second avatar representing a second user in the virtual reality environment, wherein the second user may be one of the one or more other users. The screen and a first avatar representing the first user may be rendered based on a second position associated with the second user in the virtual reality environment on a second computing device associated with a second user of the one or more other users. The screen rendered by the second computing device and the second position of the second user may have the predefined spatial relationship in the virtual reality environment rendered by the second computing device. The screen rendered by the second computing device and the first avatar representing the first user may have a different spatial relationship than the predefined spatial relationship in the virtual reality environment rendered by the second computing device.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example artificial reality system.

FIG. 2 illustrates example interactions between a control computing device and a computing device connected to a VR device.

FIGS. 3A-3C illustrate example virtual environments for co-experiencing digital content rendered by computing devices associated with participating users.

FIGS. 4A-4B illustrate example re-renderings of avatars to synchronize facing directions of the avatars to the facing directions of corresponding users.

FIG. 5 illustrates an example method for rendering a virtual environment for co-experiencing digital content.

FIG. 6 illustrates an example network environment associated with a social-networking system.

FIG. 7 illustrates an example social graph.

FIG. 8 illustrates an example computer system.

### DESCRIPTION OF EXAMPLE EMBODIMENTS

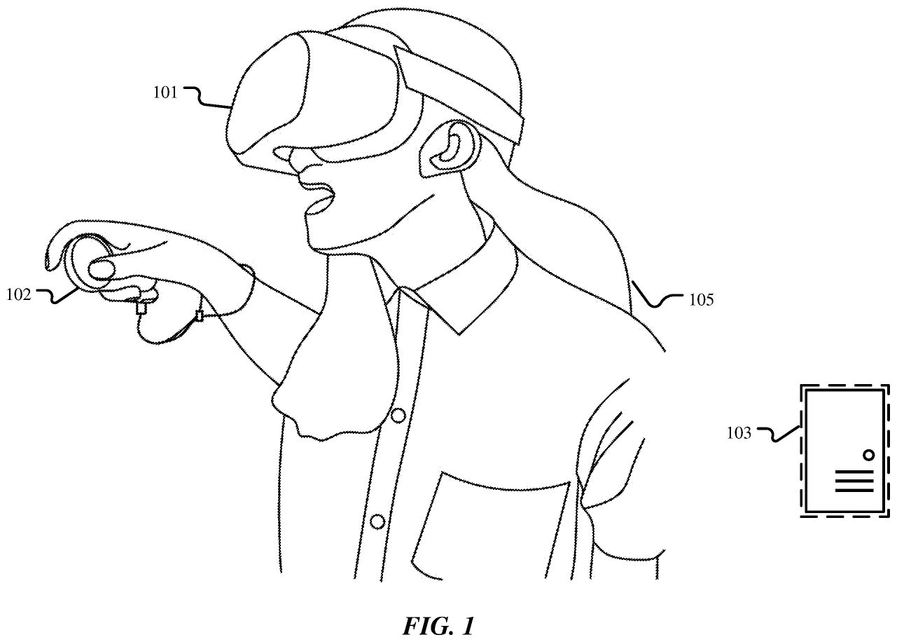

FIG. 1 illustrates an example artificial reality system. Artificial reality is a form of reality that has been adjusted in some manner before presentation to a user 105, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The example artificial reality system illustrated in FIG. 1 may comprise a head-mounted display (HMD) 101, a controller 102, and a computing device 103. A user 105 may wear a head-mounted display (HMD) 101 that may provide visual artificial reality content to the user 105. The HMD 101 may include an audio device that may provide audio artificial reality content to the user 105. A controller 102 may comprise a trackpad and one or more buttons. The controller 102 may receive input from the user 105 and relay the input to the computing device 103. The controller 102 may also provide haptic feedback to the user 105. The computing device 103 may be connected to the HMD 101 and the controller 102. The computing device 103 may control the HMD 101 and the controller 102 to provide the artificial reality content to the user and receive input from the user 105. The computing device 103 may be a standalone host computer system, combined with the HMD 101, a mobile device, or any other hardware platform capable of providing artificial reality content to one or more users 105 and receive input from the users 105.

In particular embodiments, a computing device 103 associated with an artificial reality system may provide a distortion-free viewing position (e.g., centered) to a user 105 who is co-experiencing digital content with the other users 105 in a virtual environment. An artificial reality system may allow a plurality of users 105 associated with virtual reality (VR) devices to co-experience digital content, such as a sports event, a movie or a TV show. Because co-experiencing is a social event among the participating users 105, the participating users 105 may need to be able to look at each other while the users 105 are talking to each other even though a visual presentation of a user 105 in the virtual environment may be a digital avatar, not the user herself. Thus, avatars representing respective users 105 may be placed on a curved seat in the virtual environment. If the screen is placed right in front of the centered user, the other users on each side may experience image distortion because the users are viewing the screen at an angle. Furthermore, users sitting on the extreme right or left may be too close to the screen. The virtual co-experiencing system may allow each user to face the screen right in front of the user. When a first user 105 joins a virtual digital content co-experiencing event, a first computing device 103 associated with a VR device for the first user 105 may determine a first position of the first user 105 in the virtual environment rendered by the first computing device. The first computing device 103 may render a screen in the virtual environment rendered by the first computing device 103 such that the screen and the first position may have a predefined spatial relationship. The predefined spatial relationship between the screen and the first position of the first user 105 may be that the screen may be positioned at a predetermined distance from the first position and the screen may be centered at and perpendicular to a sightline of the user when the user 105 faces forward. The first computing device 103 may render a second avatar representing a second user 105 that is also participating to the virtual digital content co-experiencing event at a second position, where a spatial relationship between the first position and the second position may be received from a computing device, and where the screen and the second position may not have the predefined spatial relationship. A second computing device 103 associated with a VR device for the second user 105 may determine a third position of the second user in the virtual environment rendered by the second computing device 103. The second computing device 103 may render a screen in the virtual environment rendered by the second computing device 103 such that the screen and the third position may have a predefined spatial relationship. The second computing device 103 may render a first avatar representing the first user 105 at a fourth position, where a spatial relationship between the fourth position and the third position in the virtual environment rendered by the second computing device 103 may be identical to the spatial relationship between the first position and the second position in the virtual environment rendered by the first computing device 103. The screen and the fourth position may not have the predefined spatial relationship in the virtual environment rendered by the second computing device 103. Although this disclosure describes providing a distortion-free viewing position to a user in a virtual environment for co-experiencing digital content in a particular manner, this disclosure contemplates providing a distortion-free viewing position to a user in a virtual environment for co-experiencing digital content in any suitable manner.

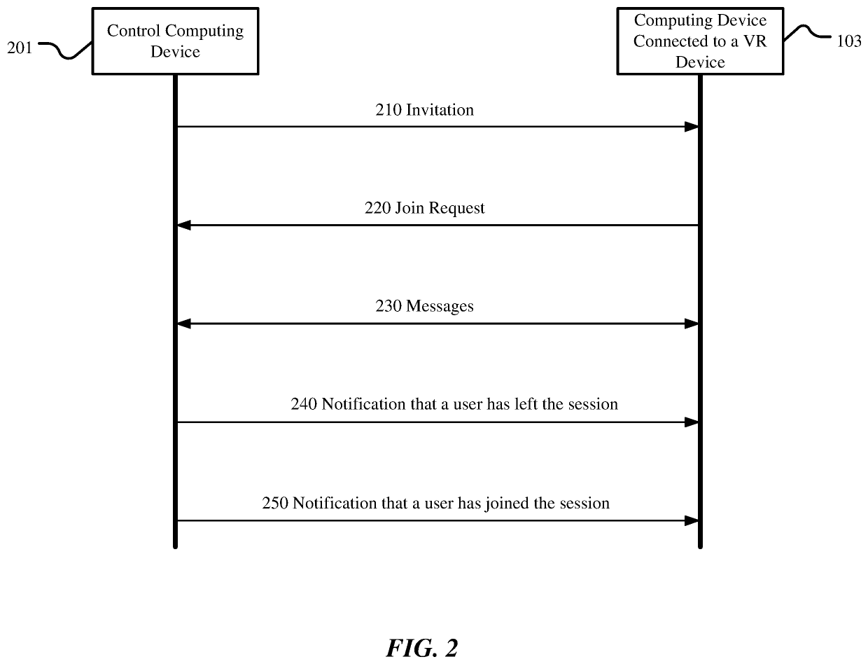

In particular embodiments, a first computing device 103 connected to a virtual reality (VR) device may be associated with a first user 105. The first computing device 103 may receive an invitation to a virtual digital content co-experiencing event from a control computing device. A user 105 may want to have the virtual digital content co-experiencing event with one or more other users 105. The user 105 may initiate sending invitations to one or more computing devices 103 associated with the one or more other users 105. The one or more computing devices 103 may be connected to respective VR devices. The first computing device 103 associated with the first user 105 may be one of the one or more computing devices. FIG. 2 illustrates example interactions between a control computing device and a computing device connected to a VR device. The computing device 103 connected to a VR device may receive an invitation 210 from a control computing device 201. As an example and not by way of limitation, Alice may want to have a watching party for a world cup match with her friends. Alice may cause a system to invite Bob, Charles, David, and Esther to a virtual co-experiencing event. A computing device 103 associated with Bob may receive the invitation 210 to the event from a control computing device 201. The computing devices 103 associated with Charles, David and Esther may also receive the invitation 210. Although this disclosure describes receiving an invitation to a virtual digital content co-experiencing event in a particular manner, this disclosure contemplates receiving an invitation to a virtual digital content co-experiencing event in any suitable manner.

In particular embodiments, the first computing device 103 may, in response to the invitation, connect to a virtual session for co-experiencing digital media content with one or more other users 105 in a virtual reality environment. To connect to the virtual session, the first computing device may send a join request 220 to the control computing device 201. The join request 220 may comprise an identifier of the first user 105 and an identifier for a first avatar selected by the first user. As an example and not by way of limitation, continuing with a prior example, the computing device 103 associated with Bob may present a message indicating that an invitation for a co-experiencing event from Alice has arrived. If Bob accepts the invitation by clicking an “Accept” button on the screen, the computing device 103 associated with Bob may ask Bob to select one of a plurality of avatars that may represent Bob during a virtual session for the co-experiencing. The computing device 103 associated with Bob may have received the plurality of avatars from the control computing device 201. The computing device 103 associated with Bob may connect to the virtual session by sending a join request 220 to the control computing device 201. The join request 220 may comprise an identifier for Bob and an identifier for the avatar that Bob has selected. As another example and not by way of limitation, continuing with a prior example, the computing device 103 associated with Charles may be configured to accept any invitation for a co-experiencing event. On receiving the invitation, the computing device 103 associated with Charles may send a join request 220 without acquiring a confirmation from Charles to the control computing device 201. The computing device 103 associated with Charles may use a pre-determined avatar to represent Charles during the virtual session. The join request 220 may comprise an identifier for Charles and an identifier for the pre-determined avatar. Although this disclosure describes joining a virtual session for a virtual co-experiencing event in a particular manner, this disclosure contemplates joining to a virtual session for a virtual co-experiencing event in any suitable manner.

In particular embodiments, the control computing device 201 may be a server managing the virtual session. In particular embodiments, communication messages 230 between the computing devices 103 associated with corresponding users 105 may be routed via the server. As an example and not by way of limitation, continuing with a prior example, the computing device 103 associated with Alice may send a request for initiating a co-experiencing event to a server that manages virtual sessions. The server may send invitations 210 to the computing devices 103 associated with Alice, Bob, Charles, David and Esther. The join requests 220 from the computing devices 103 may be sent to the server. When the computing devices 103 associated with corresponding users exchange messages 230 with each other, the messages 230 may be routed through the server. Although this disclosure describes a server managing the virtual session in a particular manner, this disclosure contemplates a server managing the virtual session in any suitable manner.

In particular embodiments, the control computing device 201 may be associated with a user 105 hosting the virtual session. The control computing device 201 may also function as a computing device 103 associated with the user. The computing devices 103 may exchange messages in an ad-hoc manner without having a control computing device 201. As an example and not by way of limitation, continuing with a prior example, on receiving a command from Alice, the computing device 103 associated with Alice may send the invitations 210 to the computing devices 103 associated with Bob, Charles, David and Esther. A computing device 103 associated with Bob, Charles, David, or Esther may send the join request 220 to the computing device 103 associated with Alice. When computing devices 103 associated with participating users 105 exchange messages, the computing devices 103 may send messages directly to the destination devices. In particular embodiments, the computing devices 103 associated with participating users 105 may route messages 230 between each other through the computing device 103 associated with Alice. Although this disclosure describes operating an ad-hoc virtual co-experiencing system in a particular manner, this disclosure contemplates operating an ad-hoc virtual co-experiencing system in any suitable manner.

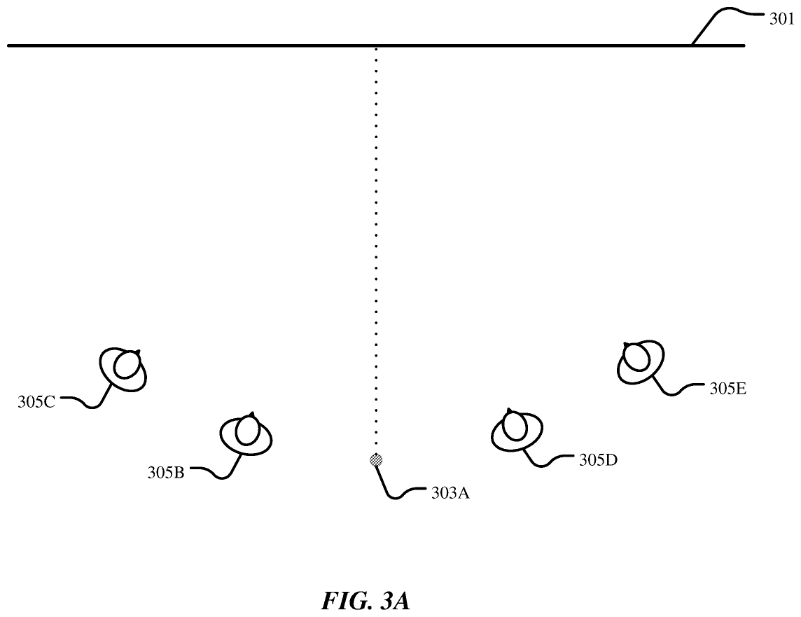

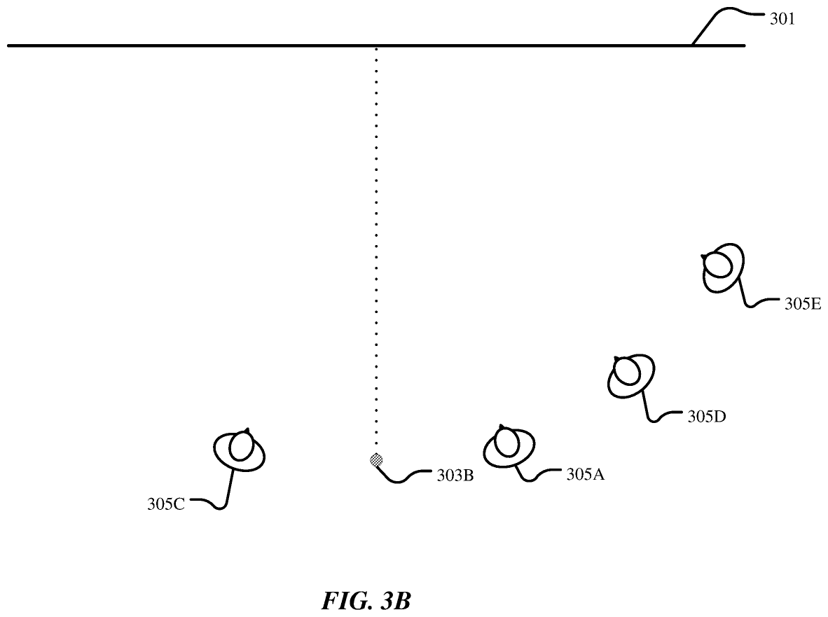

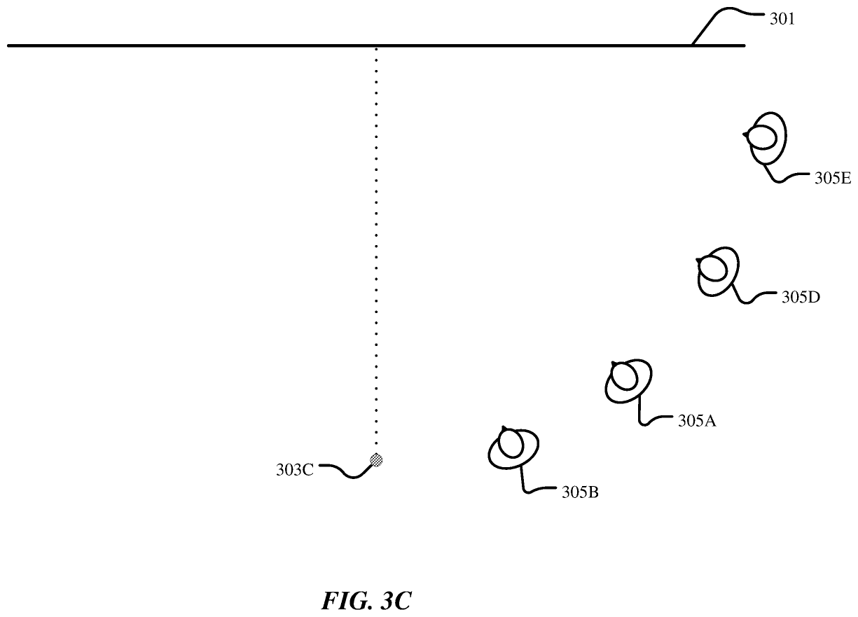

In particular embodiments, the control computing device 201 may assign a relative position to the first user in a virtual reality environment. The control computing device 201 may maintain associations between participating users and their corresponding avatars at respective relative positions. FIGS. 3A-3C illustrate example virtual environments for co-experiencing digital content rendered by computing devices associated with participating users. As an example and not by way of limitation, continuing with a prior example, the control computing device 201 may receive join requests 220 from computing devices 103 associated with Alice, Bob, Charles, David and Esther. The control computing device 201 may assign a relative location to each user in the virtual environment. An avatar 305A corresponding to Alice may be assigned to a third place from left in the virtual environment. An avatar 305B corresponding to Bob may be assigned to a second place from left in the virtual environment. An avatar 205C corresponding to Charles may be assigned to a first place from left in the virtual environment. An avatar 205D corresponding to David may be assigned to a fourth place from left in the virtual environment. And, an avatar 205E corresponding to Esther may be assigned to a fifth place from left in the virtual environment. Although this disclosure describes maintaining associations between users and their corresponding avatars at respective relative positions in a particular manner, this disclosure contemplates maintaining associations between users and their corresponding avatars at respective relative positions in any suitable manner.

In particular embodiments, the first computing device 103 may receive relative-position information indicating relative positions between the first user and the one or more other users in the virtual reality environment from the control computing device 201. The first computing device 103 may also receive information regarding avatars corresponding to the one or more other users from the control computing device 201. As an example and not by way of limitation, continuing with a prior example, the computing device 103 associated with Alice may receive, from a control computing device 201, information indicating that the avatar 305B corresponding Bob is placed at a first position on the left-hand side of Alice, the avatar 305C corresponding Charles is placed at a second position on the left-hand side of Alice, the avatar 305D corresponding to David is placed at a first position on the right-hand side of Alice, and the avatar 305E corresponding to Esther is placed at a second position on the right-hand side of Alice. As another example and not by way of limitation, continuing with a prior example, the computing device 103 associated with Bob may receive, from the control computing device 201, information indicating that the avatar 305C corresponding Charles is placed at a first position on the left-hand side of Bob, the avatar 305A corresponding to Alice is placed at a first position on the right-hand side of Bob, the avatar 305D corresponding to David is placed at a second position on the right-hand side of Bob, and the avatar 305E corresponding to Esther is placed at a third position on the right-hand side of Bob. As yet another example and not by way of limitation, continuing with a prior example, the computing device 103 associated with Charles may receive, from the control computing device 201, information indicating that the avatar 305B corresponding Bob is placed at a first position on the right-hand side of Charles, the avatar 305A corresponding to Alice is placed at a second position on the right-hand side of Charles, the avatar 305D corresponding to David is placed at a third position on the right-hand side of Charles, and the avatar 305E corresponding to Esther is placed at a fourth position on the right-hand side of Charles. Although this disclosure describes receiving relative-position information indicating relative positions between the position of the user and positions for avatars corresponding to the other users in a particular manner, this disclosure contemplates receiving relative-position information indicating relative positions between the position of the user and positions for avatars corresponding to the other users in any suitable manner.

In particular embodiments, the virtual reality environment may comprise a screen 301 for displaying the digital media content. The first computing device 103 may render the screen 301 based on a first position of the first user 105 in the virtual reality environment rendered by the first computing device 103. The screen 301 and the first position of the first user 105 may have a predefined spatial relationship in the virtual reality environment rendered by the first computing device 103. The predefined spatial relationship between the screen 301 and the first position of the first user 105 in the virtual reality environment rendered by the first computing device 103 may be that the screen 301 may be positioned at a predetermined distance from the first position and the screen 301 may be centered at and perpendicular to a sightline of the first user 105 when the first user 105 faces forward. FIG. 3A illustrates example virtual environment for co-experiencing digital content rendered by the computing device 103 associated with Alice. As an example and not by way of limitation, illustrated in FIG. 3A, the computing device 103 associated with Alice may determine a first position 303A of Alice in the virtual environment. The computing device 103 may render the screen 301 at a predetermined distance from the first position 303A. The screen 301 may be centered at and perpendicular to a sightline of Alice when Alice faces forward in the virtual environment rendered by the computing device 103 associated with Alice. Although this disclosure describes rendering a screen in the virtual environment in a particular manner, this disclosure contemplates rendering a screen in the virtual environment in any suitable manner.

In particular embodiments, the first computing device 103 may render a second avatar representing a second user at a second position in the virtual reality environment rendered by the first computing device 103 based on the received relative-position information and the first position of the first user. The second user may be one of the one or more other users. The screen 301 and the second position may not have the predefined spatial relationship in the virtual environment rendered by the first computing device 103. As an example and not by way of limitation, continuing with a prior example illustrated in FIG. 3A, the computing device 103 associated with Alice may render avatars 305B corresponding to Bob, 305C corresponding to Charles, 305D corresponding to David and 305E corresponding to Esther at their respective positions in the virtual environment rendered by the computing device 103 associated with Alice. The positions of the avatars 305B, 305C, 305D, and 305E may be determined based on the received relative-position information and the first position 303A of Alice. None of the avatars 305B, 305C, 305D, and 305E may be aligned to the center of the screen 301 in the virtual environment rendered by the computing device 103 associated with Alice. Although this disclosure describes rendering avatars for the other user in the virtual environment in a particular manner, this disclosure contemplates rendering avatars for the other user in the virtual environment in any suitable manner.

In particular embodiments, a second computing device 103 associated with the second user 105 may receive relative-position information indicating relative positions between the second user and one or more other users comprising the first user 105 in the virtual reality environment. The second computing device 103 may render the screen 301 and a first avatar, at a third position, representing the first user 105 based on a fourth position associated with the second user in the virtual reality environment rendered by the second computing device. The screen 301 rendered by the second computing device 103 and the fourth position of the second user 105 may have the predefined spatial relationship in the virtual reality environment rendered by the second computing device 103. The screen 103 and the third position may have a different spatial relationship than the predefined spatial relationship in the virtual reality environment rendered by the second computing device 103. FIG. 3B illustrates example virtual environment for co-experiencing digital content rendered by the computing device 103 associated with Bob. As an example and not by way of limitation, continuing with a prior example, illustrated in FIG. 3B, the computing device 103 associated with Bob may determine a position 303B for Bob in the virtual environment rendered by the computing device 103 associated with Bob. The computing device 103 associated with Bob may render the screen 301 at a predetermined distance from the position 303B. The screen 301 may be centered at and perpendicular to a sightline of Bob when Bob faces forward in the virtual environment rendered by the computing device 103 associated with Bob. The computing device may also render avatars 305A for Alice, 305C for Charles, 305D for David, and 305E for Esther based on the position 303B of Bob and the received relative-position information. The received relative-position information may indicate that the avatar 305C corresponding Charles is placed at a first position on the left-hand side of Bob, the avatar 305A corresponding to Alice is placed at a first position on the right-hand side of Bob, the avatar 305D corresponding to David is placed at a second position on the right-hand side of Bob, and the avatar 305E corresponding to Esther is placed at a third position on the right-hand side of Bob. None of the avatars 305A, 305C, 305D, and 305E may be aligned to the center of the screen 301 in the virtual environment rendered by the computing device 103 associated with Bob. FIG. 3C illustrates example virtual environment for co-experiencing digital content rendered by the computing device 103 associated with Charles. As an example and not by way of limitation, continuing with a prior example, illustrated in FIG. 3C, the computing device 103 associated with Charles may determine a position 303C for Charles in the virtual environment rendered by the computing device 103 associated with Charles. The computing device 103 associated with Charles may render the screen 301 at a predetermined distance from the position 303C. The screen 301 may be centered at and perpendicular to a sightline of Charles when Charles faces forward in the virtual environment rendered by the computing device 103 associated with Charles. The computing device may also render avatars 305A for Alice, 305B for Bob, 305D for David, and 305E for Esther based on the position 303C of Charles and the received relative-position information. The received relative-position information may indicate that the avatar 305B corresponding Bob is placed at a first position on the right-hand side of Charles, the avatar 305A corresponding to Alice is placed at a second position on the right-hand side of Charles, the avatar 305D corresponding to David is placed at a third position on the right-hand side of Charles, and the avatar 305E corresponding to Esther is placed at a fourth position on the right-hand side of Charles. None of the avatars 305A, 305B, 305D, and 305E may be aligned to the center of the screen 301 in the virtual environment rendered by the computing device 103 associated with Charles. Although this disclosure describes rendering a screen and avatars for other participating users in the virtual environment in a particular manner, this disclosure contemplates rendering a screen and avatars for other participating users in the virtual environment in any suitable manner.

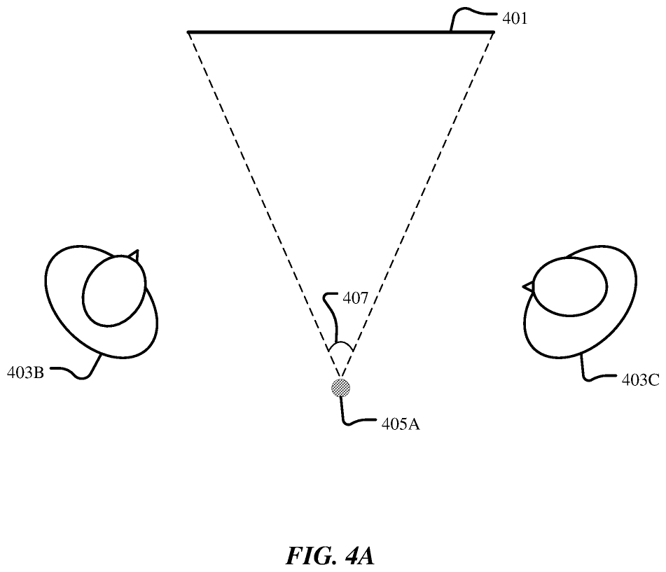

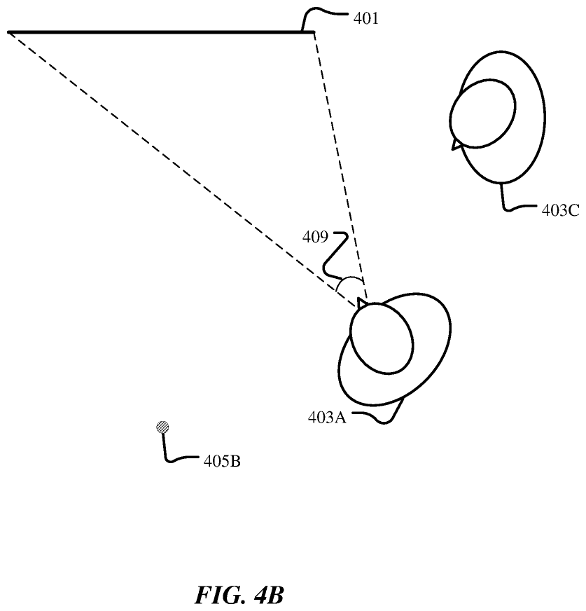

FIGS. 4A-4B illustrate example re-renderings of avatars to synchronize facing directions of the avatars to the facing directions of corresponding users. In particular embodiments, the first computing device 103 may receive a notification that a facing direction of the second user has changed from a first direction to a second direction. In particular embodiments, the notification may be directly received from the second computing device 103 associated with the second user 105. In particular embodiments, the notification may be routed through the control computing device 201. The first computing device 103 re-render the second avatar corresponding to the second user 105 in the virtual reality environment rendered by the first computing device to synchronize a facing direction of the second avatar in the virtual environment to the facing direction of the second user. FIG. 4A illustrates an example re-rendering of avatars to synchronize facing directions of the avatars to the facing directions of corresponding users in the virtual environment rendered by the first computing device 103. As an example and not by way of limitation, illustrated in FIG. 4A, a first computing device 103 associated with a first user 105 determined a first position 405A for the first user and rendered the screen 401, a second avatar 403B for a second user 105, and a third avatar 403C for a third user 105. The first computing device may re-render the second avatar 403B upon receiving a notification that the facing direction of the second user has changed toward the screen 401. The first computing device may re-render the third avatar 403C upon receiving a notification that the facing direction of the third user has changed toward the second avatar 403B. Currently, the first user is facing toward the screen 401. As long as the first computing device 103 detects that the facing direction of the first user 105 is within a pre-determined range 407, the first computing device 103 may determine that the first user 105 is facing toward the screen 401. In particular embodiments, the first computing device 103 may send a notification to the other computing devices associated with the other participating users whenever the first computing device 103 detects that the facing direction of the first user 105 changes more than a pre-determined threshold. Upon receiving the notification, the second computing device of the other computing devices may determine whether the first user is facing the screen 401 by determining that the facing direction is within the pre-determined range 407. FIG. 4B illustrates an example re-rendering of avatars to synchronize facing directions of the avatars to the facing directions of corresponding users in the virtual environment rendered by the second computing device 103. As another example and not by way of limitation, continuing with the prior example, illustrated in FIG. 4B, the second computing device 103 associated with the second user 105 determined a second position 405B as the position of the second user 105 and rendered the screen 401, the first avatar 403A for the first user, and the third avatar 403C for the third user in the virtual environment rendered by the second computing device 103 based on the second position 405B and the received relative-position information. The second computing device 103 may receive a notification that the facing direction of the first user 105 changed to a destination direction that is within the pre-determined range 407. Upon receiving the notification, the second computing device 103 may determine that the destination direction is within the pre-determined range 407 of directions to the screen within the virtual reality environment rendered by the first computing device. The second computing device 103 may re-render, in response to the determination, the first avatar 403A such that the first avatar 403A is facing the screen 401 by turning the head toward a direction within a range 409 in the virtual environment rendered by the second computing device 103 even though the first user is actually facing directly forward to the screen 401 in the virtual environment rendered by the first computing device 103. Although this disclosure describes re-rendering an avatar to synchronize a facing direction of the avatar in the virtual environment to the facing direction of the corresponding user in a particular manner, this disclosure contemplates re-rendering an avatar to synchronize a facing direction of the avatar in the virtual environment to the facing direction of the corresponding user in any suitable manner.

In particular embodiments, the first computing device 103 may receive a notification that a second user has left the virtual session 240 from the control computing device 201. The notification 240 may comprise an identifier of the second user. The first computing device 103 may remove a second avatar corresponding to the second user from the virtual reality environment rendered by the first computing device 103. Although this disclosure describes removing an avatar upon receiving a notification that the corresponding user has left the virtual session in a particular manner, this disclosure contemplates removing an avatar upon receiving a notification that the corresponding user has left the virtual session in any suitable manner.

In particular embodiments, the first computing device 103 may receive a notification that a new user has joined the virtual session 250 from the control computing device 201. The notification 250 may comprise an identifier of the new user and relative-position information comprising a relative position of the new user. The notification 250 may also comprise an identifier of an avatar representing the new user in the virtual session. The first computing device 103 may render the avatar corresponding to the new user in the virtual reality environment rendered by the first computing device 103 based on the first position of the first user and the received relative-position information. Although this disclosure describes rendering a new avatar upon receiving a notification that a new user has joined the virtual session in a particular manner, this disclosure contemplates rendering a new avatar upon receiving a notification that a new user has joined the virtual session in any suitable manner.

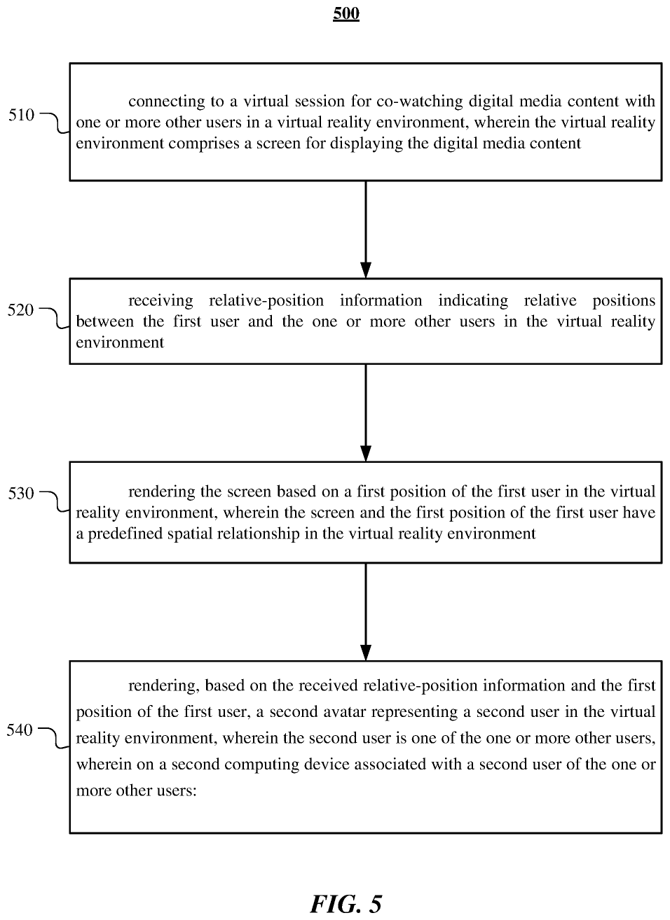

FIG. 5 illustrates an example method 500 for rendering a virtual environment for co-experiencing digital content. The method may begin at step 510, where a first computing device 103 associated with a first user 105 may connect to a virtual session for co-experiencing digital media content with one or more other users in a virtual reality environment, wherein the virtual reality environment comprises a screen for displaying the digital media content. At step 520, the first computing device 103 may receive relative-position information indicating relative positions between the first user and the one or more other users in the virtual reality environment. At step 530, the first computing device 103 may render the screen based on a first position of the first user in the virtual reality environment, wherein the screen and the first position of the first user have a predefined spatial relationship in the virtual reality environment. At step 540, the first computing device 103 may render, based on the received relative-position information and the first position of the first user, a second avatar representing a second user in the virtual reality environment, wherein the second user is one of the one or more other users, wherein on a second computing device associated with a second user of the one or more other users: the screen and a first avatar representing the first user are rendered based on a second position associated with the second user in the virtual reality environment, the screen rendered by the second computing device and the second position of the second user have the predefined spatial relationship in the virtual reality environment, and the screen rendered by the second computing device and the first avatar representing the first user have a different spatial relationship in the virtual reality environment than the predefined spatial relationship. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for rendering a virtual environment for co-experiencing digital content including the particular steps of the method of FIG. 5, this disclosure contemplates any suitable method for rendering a virtual environment for co-experiencing digital content including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### System Overview

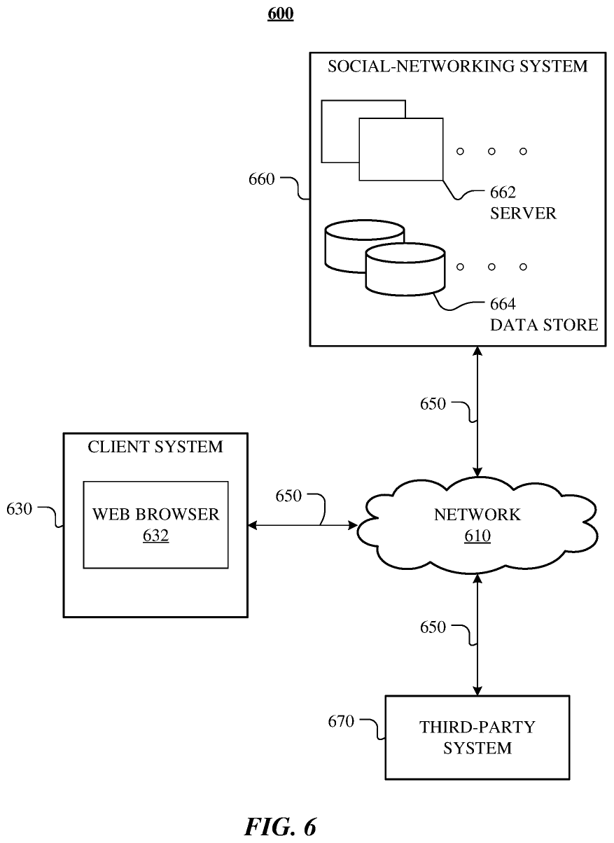

FIG. 6 illustrates an example network environment 600 associated with a social-networking system. Network environment 600 includes a client system 630, a social-networking system 660, and a third-party system 670 connected to each other by a network 610. Although FIG. 6 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 6 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular embodiments, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular embodiments, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular embodiments, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular embodiments, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 662 may include hardware, software, or embedded logic components or a combination of two or more such components for carrying out the appropriate functionalities implemented or supported by server 662. In particular embodiments, social-networking system 660 may include one or more data stores 664. Data stores 664 may be used to store various types of information. In particular embodiments, the information stored in data stores 664 may be organized according to specific data structures. In particular embodiments, each data store 664 may be a relational, columnar, correlation, or other suitable database. Although this disclosure describes or illustrates particular types of databases, this disclosure contemplates any suitable types of databases. Particular embodiments may provide interfaces that enable a client system 630, a social-networking system 660, or a third-party system 670 to manage, retrieve, modify, add, or delete, the information stored in data store 664.

In particular embodiments, social-networking system 660 may store one or more social graphs in one or more data stores 664. In particular embodiments, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular embodiments, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular embodiments, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular embodiments, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular embodiments, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular embodiments, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular embodiments, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular embodiments, social-networking system 660 may include a variety of servers, sub-systems, programs, modules, logs, and data stores. In particular embodiments, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular embodiments, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

### Social Graphs

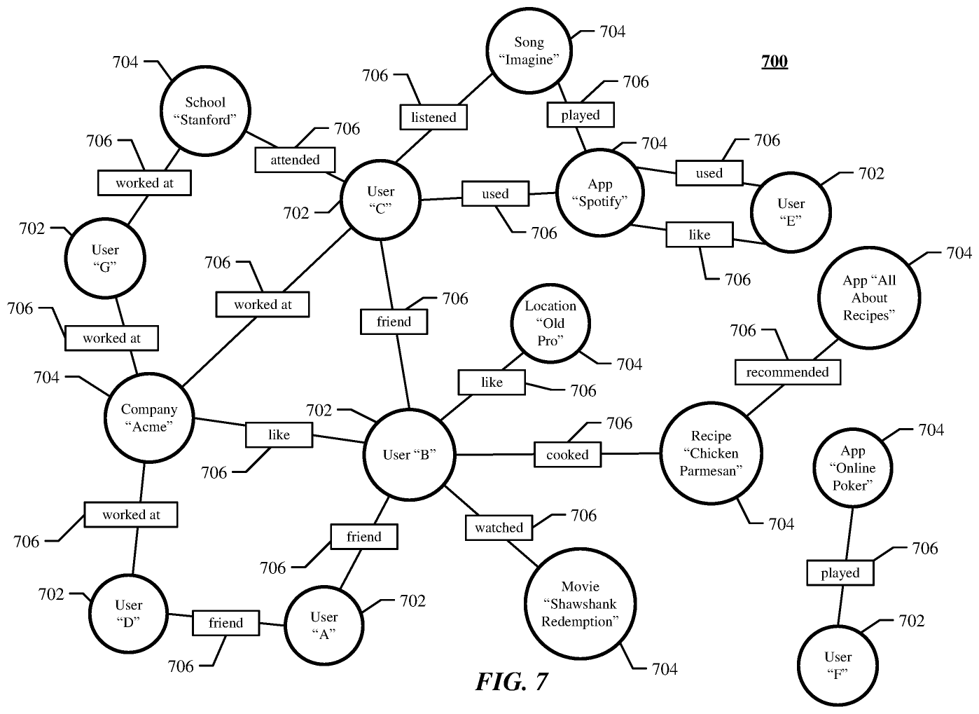

FIG. 7 illustrates example social graph 700. In particular embodiments, social-networking system 660 may store one or more social graphs 700 in one or more data stores. In particular embodiments, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 7 is shown, for didactic purposes, in a two-dimensional visual map representation. In particular embodiments, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular embodiments, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular embodiments, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 660 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular embodiments, social-networking system 660 may store an edge 706 in one or more data stores. In particular embodiments, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Systems and Methods

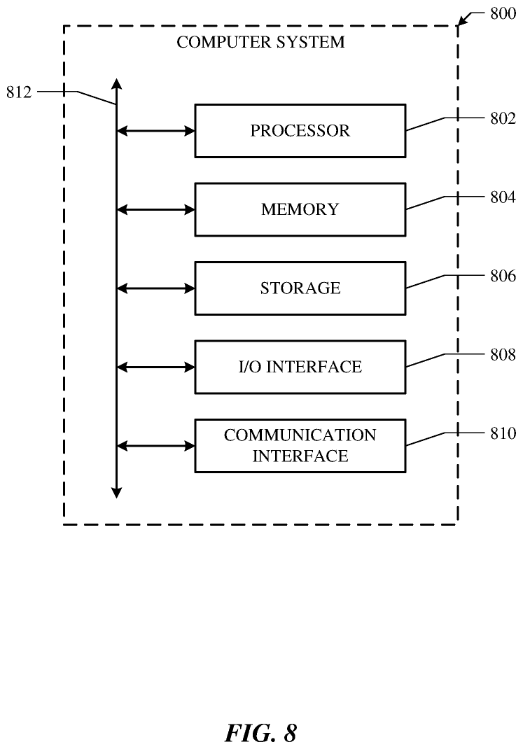

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a first computing device associated with a first user, connecting to a virtual session for co-experiencing digital media content with one or more other users in a virtual reality environment, wherein the virtual reality environment comprises a screen for displaying the digital media content;
by the first computing device, receiving relative-position information indicating relative positions between the first user and the one or more other users in the virtual reality environment;
by the first computing device, rendering the screen based on a first position of the first user in the virtual reality environment, wherein the screen and the first position of the first user have a predefined spatial relationship in the virtual reality environment; and
by the first computing device, rendering, based on the received relative-position information and the first position of the first user, a second avatar representing a second user in the virtual reality environment, wherein the second user is one of the one or more other users;
wherein on a second computing device associated with a second user of the one or more other users:
the screen and a first avatar representing the first user are rendered based on a second position associated with the second user in the virtual reality environment;
the screen rendered by the second computing device and the second position of the second user have the predefined spatial relationship in the virtual reality environment; and
the screen rendered by the second computing device and the first avatar representing the first user have a different spatial relationship in the virtual reality environment than the predefined spatial relationship.

2. The method of claim 1, wherein connecting to the virtual session is in response to an invitation from a third computing device.

3. The method of claim 2, wherein connecting to the virtual session comprises sending a join request to the third computing device, wherein the join request comprises an identifier of the first user and an identifier for the first avatar selected by the first user.

4. The method of claim 3, wherein the third computing device assigns a relative position to the first user in the virtual reality environment.

5. The method of claim 3, wherein the third computing device maintains associations between participating users and their corresponding avatars at respective positions.

6. The method of claim 3, wherein the third computing device is a server managing the virtual session.

7. The method of claim 6, wherein communication messages between the computing devices are routed via the server.

8. The method of claim 3, wherein the third computing device is associated with a user hosting the virtual session.

9. The method of claim 1, wherein the predefined spatial relationship between the screen and a position of a user in the virtual reality environment is that the screen is positioned at a predetermined distance from the position and the screen is centered at and perpendicular to a sightline of the user when the user faces forward.

10. The method of claim 1, further comprising:
by the first computing device, receiving a notification that a facing direction of the second user has changed from a first direction to a second direction; and
by the first computing device, re-rendering the second avatar corresponding to the second user in the virtual reality environment rendered by the first computing device to synchronize a facing direction of the second avatar to the facing direction of the second user.

11. The method of claim 10, wherein re-rendering the second avatar comprises:
determining that the second direction is within a pre-determined range of directions to the screen within the virtual reality environment rendered by the second computing device; and
rendering, in response to the determination, the second avatar such that the second avatar faces the screen in the virtual reality environment rendered by the first computing device.

12. The method of claim 2, further comprising:
by the first computing device, receiving, from the third computing device, a notification that the second user has left the virtual session, wherein the notification comprises an identifier of the second user; and
by the first computing device, removing the second avatar corresponding to the second user from the virtual reality environment.

13. The method of claim 2, further comprising:
by the first computing device, receiving, from the third computing device, a notification that a new user has joined the virtual session, wherein the notification comprises an identifier of the new user and relative-position information comprising relative position of the new user; and
by the first computing device, rendering, based on the first position and the received relative-position information, a third avatar corresponding to the new user in the virtual reality environment.

14. One or more computer-readable non-transitory storage media embodying software that is operable on a first computing device associated with a first user when executed to:
connect to a virtual session for co-experiencing digital media content with one or more other users in a virtual reality environment, wherein the virtual reality environment comprises a screen for displaying the digital media content;
receive relative-position information indicating relative positions between the first user and the one or more other users in the virtual reality environment;
render the screen based on a first position of the first user in the virtual reality environment, wherein the screen and the first position of the first user have a predefined spatial relationship in the virtual reality environment; and
render, based on the received relative-position information and the first position of the first user, a second avatar representing a second user in the virtual reality environment, wherein the second user is one of the one or more other users;
wherein on a second computing device associated with a second user of the one or more other users:
the screen and a first avatar representing the first user are rendered based on a second position associated with the second user in the virtual reality environment;
the screen rendered by the second computing device and the second position of the second user have the predefined spatial relationship in the virtual reality environment; and
the screen rendered by the second computing device and the first avatar representing the first user have a different spatial relationship in the virtual reality environment than the predefined spatial relationship.

15. The media of claim 14, wherein connecting to the virtual session is in response to an invitation from a third computing device.

16. The media of claim 15, wherein connecting to the virtual session comprises sending a join request to the third computing device, wherein the join request comprises an identifier of the first user and an identifier for the first avatar selected by the first user.

17. The media of claim 16, wherein the third computing device assigns a relative position to the first user in the virtual reality environment.

18. The media of claim 16, wherein the third computing device maintains associations between participating users and their corresponding avatars at respective positions.

19. The media of claim 16, wherein the third computing device is a server managing the virtual session.

20. A first computing device associated with a first user comprising:
one or more processors; and
one or more computer-readable non-transitory storage media coupled to one or more of the processors and comprising instructions operable when executed by one or more of the processors to cause the system to:
connect to a virtual session for co-experiencing digital media content with one or more other users in a virtual reality environment, wherein the virtual reality environment comprises a screen for displaying the digital media content;
receive relative-position information indicating relative positions between the first user and the one or more other users in the virtual reality environment;
render the screen based on a first position of the first user in the virtual reality environment, wherein the screen and the first position of the first user have a predefined spatial relationship in the virtual reality environment; and
render, based on the received relative-position information and the first position of the first user, a second avatar representing a second user in the virtual reality environment, wherein the second user is one of the one or more other users;
wherein on a second computing device associated with a second user of the one or more other users:
the screen and a first avatar representing the first user are rendered based on a second position associated with the second user in the virtual reality environment;
the screen rendered by the second computing device and the second position of the second user have the predefined spatial relationship in the virtual reality environment; and
the screen rendered by the second computing device and the first avatar representing the first user have a different spatial relationship in the virtual reality environment than the predefined spatial relationship.
